(19) United States
(12) Patent Application Publication
(10) Pub. No.: US 2011/0258020 A1
(43) Pub. Date: Oct. 20, 2011

(54) EVALUATING INITIATIVES

(75) Inventors: Shreekant W. Shiralkar, Mumbai (IN); Phani Kumar Bokka, Andhra Pradesh (IN); Vibha Gupta, Uttar Pradesh (IN)

(73) Assignee: Accenture Global Services GmbH, Schaffhausen (CH)

(21) Appl. No.: 12/839,501

(22) Filed: Jul. 20, 2010

(30) Foreign Application Priority Data
Apr. 20, 2010 (IN) 1122/CHE/2010

(51) Int. Cl. G06Q 10/00

(52) U.S. Cl. 705/7.37

(57) ABSTRACT

Technology development initiatives are objectively evaluated using a framework that includes a set of evaluation parameters and scoring rules. Predefined evaluation parameter values are associated with the evaluation parameters. The evaluation parameters are also associated with scoring rules that can be used to generate score component associated with the evaluation parameters. The evaluation parameters are also grouped and the score components associated with the evaluation parameters are modified based on a scoring rule for the evaluation parameter group. The modified score components are used to generate final scores for the technology development initiatives, and the final scores are used to evaluate the technology development initiatives relative to other initiatives or relative to thresholds.

### CROSS-REFERENCE TO RELATED APPLICATION

This application claims priority to and the benefit of Indian Patent Application No. 1122/CHE/2010, filed in the Indian Patent Office on Apr. 20, 2010 and titled Evaluating Initiatives, the entire contents of which are incorporated by reference.

### TECHNICAL FIELD

This disclosure relates to evaluating initiatives.

### BACKGROUND

In many different environments, proposed projects are reviewed and a decision is made whether to initiate implementation of the proposed project. Where resources are limited, budgetary concerns and other resource allocation concerns may be considered as factors in making the decision. Thus, two or more proposed projects may compete for limited funding, such that proceeding with one or more projects results in one or more other projects not receiving funding from a particular funding source. In some situations, a panel or group of individuals may be responsible for making decisions about whether or not to initiate implementation of any given proposed project. If a proposed project is speculative in nature, it can be difficult to evaluate the project and to compare its potential benefits with an estimation of potential costs and risks. In some cases, two different individuals can evaluate a given proposal for a new project differently, possibly using different standards and considering different criteria. Thus, there is a possibility that two individuals will come to different conclusions regarding whether to initiate implementation of the given proposal. Similarly, two proposals may not be evaluated consistently by the same individual. Such inconsistencies can undermine efforts to maximize the benefits achieved with a given budget or other limited resource since. For example, resources may be allocated to an objectively worse or lower-value project instead of to objectively better or higher-value projects due to the subjectivity of the proposal evaluation process.

### SUMMARY

In order to consistently evaluate proposals, such as investment opportunities, which may include certain types of technology development initiatives or research and development projects, organization, such as a service delivery organization, can use an evaluation framework that includes standard evaluation parameters or criteria and standard evaluation parameter scoring rules. By using the evaluation framework, the service delivery organization can make investment decisions based on a consistent evaluation of investment opportunities to invest in the investment opportunities that will most likely have the greatest ability to enhance service delivery and create service excellence. Thus, the service delivery organization can gain a strategic advantage over competing organizations.

The standard evaluation parameter scoring rules are designed to produce an objective score component for each of the standard evaluation parameters based on a received value for the evaluation parameter attributed to an initiative or project. Additionally, the standard evaluation parameters can be organized in groups and the score components for the evaluation parameters of a group can be processed according to a scoring rule for the group. A final score for an initiative or project can thus be generated based on the score components associated with each of the evaluation parameters and the scoring rule for each of the groups of evaluation parameters.

For example, each of the values for the evaluation parameters can be selected from a pre-defined set of possible values. Based on which value is selected, an associated score component can be attributed to an initiative or proposal according to the scoring rule for the associated evaluation parameter. When all of the score components for an initiative or proposal have been determined, the scoring rules for the groups of evaluation parameters can be applied to the score components to obtain final score components for the initiative or proposal. For example, each group may be weighted according to a multiplier, such that the score components for the evaluation parameters in a group may be multiplied by the multiplier to obtain the final score components for the evaluation parameters of the group. These final score components can be summed to obtain the final score for the initiative or proposal.

Additionally, after an investment opportunity has been approved for resource allocation, an implementation of the initiative or proposal can be reviewed using the same framework. For example, on an ongoing basis, such as quarterly, current values of the evaluation parameters can be selected for each of the evaluation parameters. A current final score can be calculated, such as by the process described above. The current final score can be used in deciding whether to continue investing in the opportunity by continuing implementation of the initiative or proposal. For example, the final score can be compared to a threshold score, the initial final score for the initiative or proposal, a previous final score for the initiative or proposal, the initial final scores of other investment opportunities under consideration for implementation, and/or the current final scores of other initiatives or proposals under review, among others.

Each group of evaluation parameters can include one or more evaluation parameters that relate to the potential of an initiative or proposal to achieve a particular result or goal. For example, a group of evaluation parameters can include one or more parameters that relate to the potential of a given technology development initiative to drive future sales for an organization considering implementing the initiative. Other groups can include evaluation parameters that relate to other aspects of a technology development initiative, or other initiatives or projects, such as the potential to improve certain skills of the organization's workforce, the potential to yield products or service offerings in a particular market or market segment, or the potential return on investment associated with the investment opportunity, among others.

Thus, by changing the scoring rules for one or more groups of evaluation parameters, the final score for an investment opportunity can be changed to reflect an organization's changing preferences or goals in investing. Additionally or alternatively, the scoring rules for one or more groups of evaluation parameters can be changed based on performance data regarding historic investment decisions, or for other reasons, without fundamentally changing the evaluation framework. For example, a multiplier associated with a group of evaluation parameters may be decreased when the aspect of the initiative or project to which the group pertains becomes less important to the organization, or as historical data illustrates that the group of evaluation parameters are less accurate predictors of achieving results than previously believed. Thus, the specific evaluation parameters, the pre-selected value sets associated with each of the evaluation parameters, and the specific scoring rules associated with each of the evaluation parameters can remain unchanged, which provides consistency in the evaluation and/or review processes for speculative investment opportunities, while allowing flexibility to produce value scores that are useful in making investment decisions in changing marketplaces.

In one general aspect, a method includes receiving, for an associated investment proposal for an organization, a selected value for each evaluation parameter of a predetermined set of evaluation parameters, the evaluation parameters being selected for evaluating one or more characteristics of investment proposals. At least one computer processor generates a score for the associated investment proposal based on the received values and a rule set. The rule set provides instructions for generating a score for an investment proposal using selected values for each evaluation parameter. The score for the associated investment proposal is output for use in evaluating the associated investment proposal.

Implementations may include one or more of the following features. For example, the selected values are selected from a predetermined set of parameter values. The method can also include receiving updated selections, generating an updated score for an initiative associated with the investment proposal, and outputting the updated score for the associated initiative for use in evaluating a progress of the initiative. The score for the associated investment proposal is output in a display that includes a score for at least one additional investment proposal. Generating the score for the associated investment proposal includes processing each selected value according to a scoring rule associated with the corresponding evaluation parameter to generate score components. The evaluation parameters are associated with parameter categories, and generating the score for the associated investment proposal includes processing the score components for each evaluation parameter in a category according to a scoring rule associated with the category.

In another general aspect, a system includes one or more receivers that receive, for an associated investment proposal for a service delivery organization, a selected value for each evaluation parameter of a predetermined set of evaluation parameters. The evaluation parameters are selected for evaluating one or more characteristics of investment proposals. The system also includes one or more computer processors that generate a score for the associated investment proposal based on the received values and a set of scoring rules. The set of scoring rules includes instructions for generating a score for an investment proposal using selected values for each evaluation parameter. One or more storage devices store the scoring rules and store the generated score.

Implementations may include one or more of the following features. For example, one or more storage devices store predetermined sets of parameter values, and the selected values are selected from the predetermined sets of parameter values. The one or more receivers receive, for an implementation associated with the investment proposal, updated selections. The one or more computer processors generate an updated score for the initiative associated with the updated selections. The one or more storage devices store the updated score for the associated initiative for use in evaluating a progress of the initiative. The system also includes a display device that displays the score for the associated investment proposal with a score for at least one additional investment proposal. The one or more computer processors generate the score for the associated investment proposal by processing each selected value according to a scoring rule associated with the corresponding evaluation parameter to generate score components. The evaluation parameters are associated with parameter categories, and the one or more computer processors generate the score for the associated investment proposal by processing the score components for each evaluation parameter in a category according to a scoring rule associated with the category.

In another general aspect, a tangible computer-readable storage medium has a computer program product stored thereon. The computer program product includes instructions that, when executed by one or more computer processors, enable receiving, for an associated investment proposal for a service delivery organization, a selected value for each evaluation parameter of a predetermined set of evaluation parameters. The evaluation parameters are selected for evaluating one or more characteristics of investment proposals. The computer program product also enables generating a score for the associated investment proposal based on the received values and a rule set, where the rule set provides instructions for generating a score for an investment proposal using selected values for each evaluation parameter. The computer program product also enables outputting the score for the associated investment proposal for use in evaluating the associated investment proposal.

Implementations may include one or more of the following features. For example, the selected values are selected from a predetermined set of parameter values. The instructions further enable receiving updated selections, generating an updated score for an initiative associated with the investment proposal, and outputting the updated score for the associated initiative for use in evaluating a progress of the initiative. The score for the associated investment proposal is output in a display that includes a score for at least one additional investment proposal. Generating the score for the associated investment proposal includes processing each selected value according to a scoring rule associated with the corresponding evaluation parameter to generate score components. The evaluation parameters are associated with parameter categories, and generating the score for the associated investment proposal includes processing the score components for each evaluation parameter in a category according to a scoring rule associated with the category.

The details of one or more implementations are set forth in the accompanying drawings and the description below. Other features will be apparent from the description and drawings, and from the claims.

### DESCRIPTION OF DRAWINGS

FIG. 1 is a schematic diagram illustrating a framework for evaluating initiatives.

FIG. 2 is a diagram illustrating a system for evaluating initiatives.

FIG. 3 is a diagram of a computer system useful in the system of FIG. 2.

FIGS. 4 and 5 are illustrations of data structures for use in evaluating initiatives.

FIGS. 6 and 7 are illustrations of a process for evaluating initiatives.

FIG. 8 is an illustration of a user interface for use in evaluating initiatives.

Like reference symbols in the various drawings indicate like elements.

### DETAILED DESCRIPTION

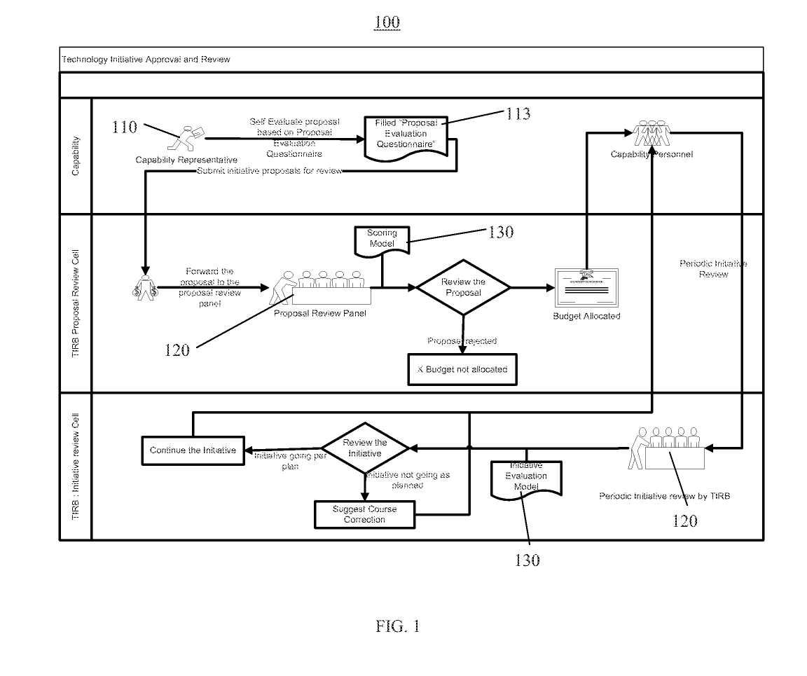

In many environments, an investment opportunity, such as a technology development initiative or other initiative or proposal, can be evaluated objectively using a framework 100 illustrated in FIG. 1 for use in making a decision regarding the investment opportunity, such as whether to allocate resources, such as by funding and implementing an initiative. Initially, a representative 110 develops or otherwise obtains a technology development initiative and submits the initiative for analysis using the framework 100. The initiative review process begins when the representative 110 completes an initiative evaluation form or questionnaire to create evaluation information 113 associated with the initiative, or otherwise creates a record of evaluation information 113. In some implementations, as discussed in greater detail below, the evaluation information 113 includes selected values for a standard set of evaluation parameters.

Once completed, the evaluation information 113 is submitted for review by members of a review panel 120. In order to provide an objective measure of value, or potential value, of the initiative, the evaluation information 113 is analyzed using a scoring model 130. The scoring model 130 is operable to provide an objective output, such as a numerical score value, a grade, a recommendation, or other output. For example, the scoring model can apply scoring rules to the selected values. The members of the review panel 120 can use the score output by the scoring model 130 to evaluate the initiative by comparing the score for the initiative with a set of review standards and/or with scores associated with other initiatives. In some implementations, the members of the review panel 120 can use the output of the scoring model 130 to make a funding decision. If the members of the review panel 120 decide to fund the initiative, the representative 110 and/or a development team can begin implementing the initiative, such as by conducting research or beginning to develop a desired technology.

At some time after work on the initiative has begun, the progress of the initiative can be analyzed. For example, the members of the review panel 120 may review the progress of the initiative in order to make a decision regarding continued funding of the initiative. In order to provide a current objective measure of the value or potential value of the initiative, taking into account the progress since the initial evaluation, the scoring model 130 can be used to generate a current score for the initiative. For example, the representative 110 can update the selected values for the evaluation parameters to create current initiative evaluation information 113. The current evaluation information can then be analyzed using the scoring model 130 to generate a current score. The members of the review panel 120 can use the current score to compare the initiative to other initiative that are being implemented, to newly proposed initiatives, or to the initial value score for the initiative. The implementation of the initiative can be continued, modified, or terminated based on the current score for the initiative. Thus, an organization can use its resources most effectively by only implementing and maintaining initiatives that have the highest value to the organization.

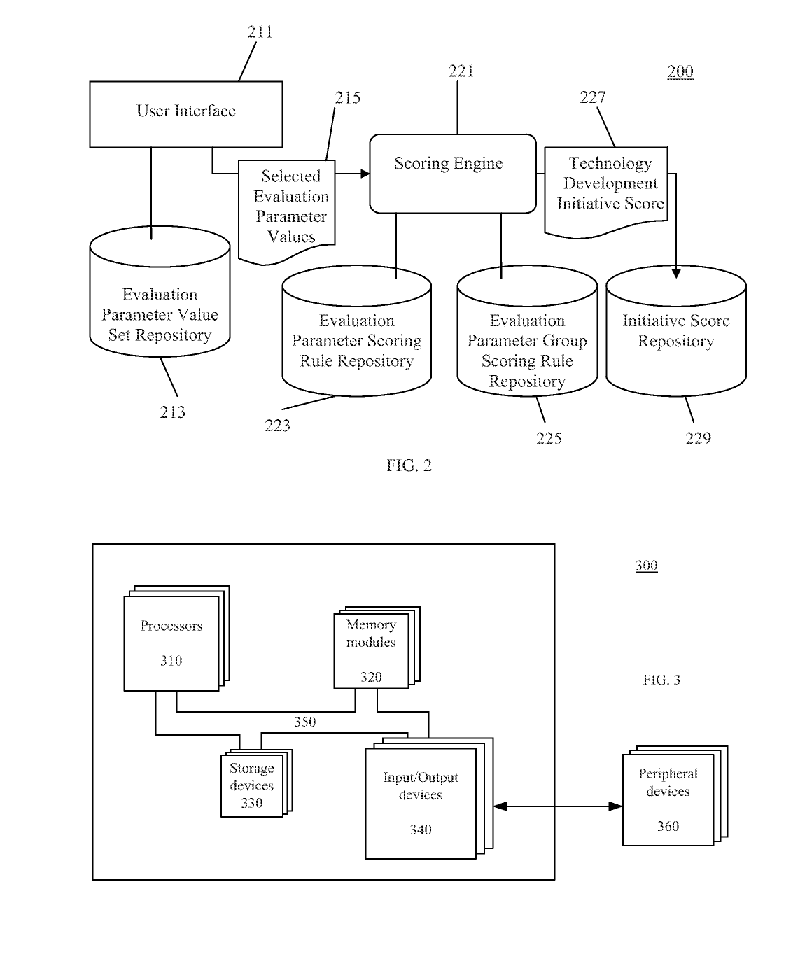

In some implementations, the framework 100 can include a system 200 illustrated in FIG. 2 for evaluating initiatives. The system 200 includes a user interface 211 that is usable by an individual, such as the representative 113, to input information regarding an initiative. As mentioned above, the information regarding the initiative can include evaluation parameter values selected by the individual. For example, the individual can use the user interface 211 to access sets of selectable evaluation parameter values stored in an evaluation parameter value set repository 213. The individual can select a value from among a set of values for multiple evaluation parameters. In some implementations, the evaluation parameters can pertain to various aspects of the technology development initiative, such as an anticipated duration of the initiative, an anticipated budget of the initiative, a type of product expected to be yielded from the initiative, or other aspect of the initiative. Thus, the selected evaluation parameter values represent objective features of the technology development initiative.

Once selected, the user interface 211 is operable to transmit a set of selected evaluation parameter values 215 to a scoring engine 221. In some implementations, the user interface 211 can be configured as a web page accessible through a web server computer, such as a user interface 800 discussed below. When the user inputs selections of evaluation parameter values, information corresponding to the selections can be stored at the server, and subsequently transmitted to the scoring engine 221.

The scoring engine 221 is operable to retrieve evaluation parameter scoring rules from an evaluation parameter scoring rule repository 223. For example, the scoring engine 221 can retrieve an evaluation parameter scoring rule for each evaluation parameter for which an evaluation parameter value has been selected. Additionally, the scoring engine 221 is operable to retrieve evaluation parameter group scoring rules from an evaluation parameter group scoring rule repository 225. For example, the scoring engine 221 can retrieve an evaluation parameter group scoring rule for each evaluation parameter group that includes an evaluation parameter for which a scoring rule has been retrieved.

Using the retrieved evaluation parameter scoring rules and the retrieved evaluation parameter group scoring rules, the scoring engine generates an objective score for the technology development initiative 227. The generated technology development initiative score 227 can be stored in an initiative score repository 229, where it can be accessed by selected individuals, such as the members of the review panel 120. For example, the scoring engine 221 can generate the technology development initiative score 227 by generating a score component for the selected evaluation parameter value for each of the evaluation parameters. Each score component is generated according to an evaluation parameter scoring rule that is associated with the corresponding evaluation parameter. The scoring engine 221 can then generate final score components for the technology development initiative by applying an evaluation parameter group scoring rule to each of the score components for the evaluation parameters of an associated evaluation parameter group. The final score components can then be used to create the final technology development initiative score 227 that is output from the scoring engine 221.

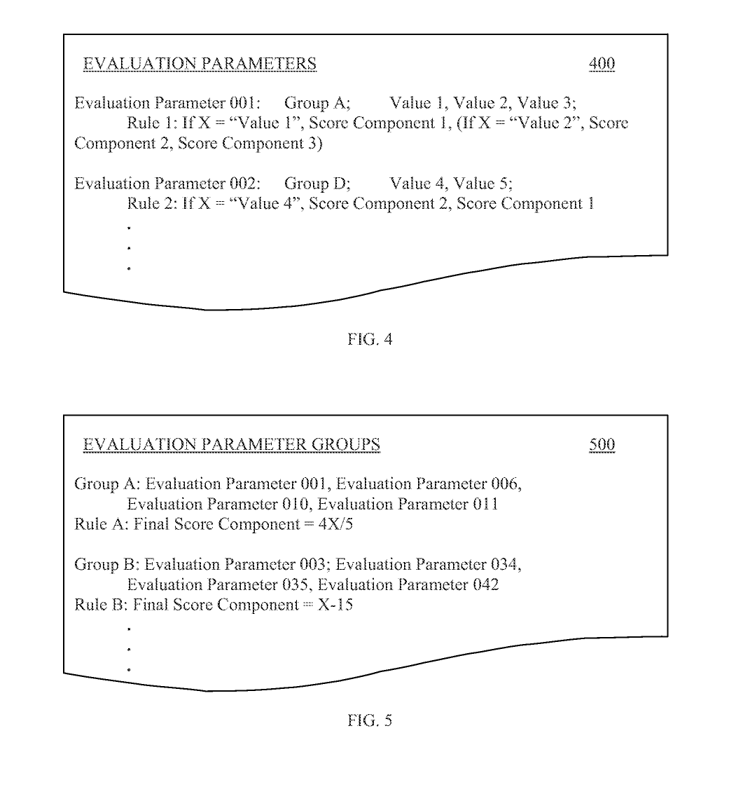

Referring to FIG. 3, the scoring model 130 and/or components thereof, and one or more components of the system 200, such as the scoring engine 221, can include one or more computer systems, such as the computer system 300 of FIG. 3, or components thereof. The computer system 300 includes one or more processors 310, memory modules 320, storage devices 330, and input-output devices 340 connected by a system bus 350. The input-output devices 340 are operable with one or more peripheral devices 360, including a communication device that is operable to communicate with other computer systems or components thereof. Other peripheral device that may be included in the computer system 300 include output devices such as displays, speakers, and printers, and input devices such as pointers, microphones, keyboards, and scanners. The one or more computer systems 300 can perform the various functions described in this disclosure by executing computer instructions embodied in computer software stored on a computer-readable storage device, such as the memory modules 320, the storage devices 330, and/or the peripheral devices 360.

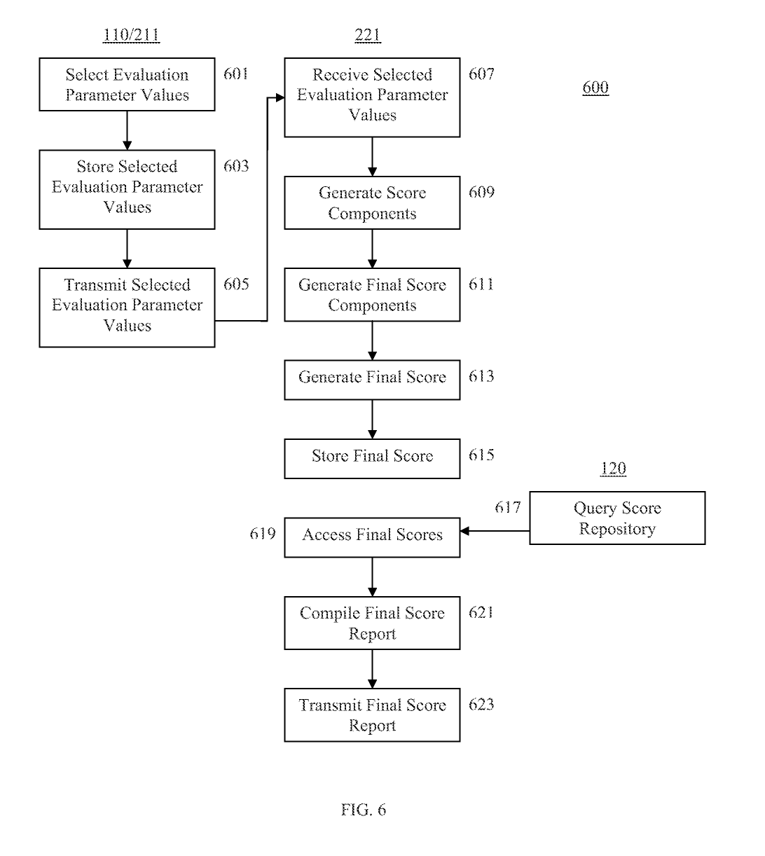

In some implementations, a data structure 400 illustrated in FIG. 4 can be stored on a storage device for use in the system 200. As shown, the data structure 400 includes information associated with each of a set of evaluation parameter, such as “evaluation parameter 001” and “evaluation parameter 002.” The information regarding evaluation parameter 001 includes an indication that the evaluation parameter 001 belongs to an evaluation parameter group “A.” The information also includes a list of possible values that can be selected for the evaluation parameter. As illustrated, the list of possible values includes “Value 1,” “Value 2,” and “Value 3.” The information included in the data structure 400 can be used, for example, by the user interface 211, to identify a set of possible evaluation parameters from which a user can select an appropriate evaluation parameter value that reflects an attribute of a technology development initiative. Based on the set of possible evaluation parameter values identified from the data structure 400, the user interface 211 can display options to a user and receive indications of selected options.

Additionally, the data structure 400 can include information regarding one or more scoring rules that can be used by the scoring engine 221 in generating a score for the initiative. For example, the scoring rule “rule 1” is associated with the evaluation parameter 001. As illustrated, the scoring rule “rule 1” is configured to assign a first score component “score component 1” to the initiative for the evaluation parameter 001 if the selected value is “value 1.” If the selected value is “value 2,” then a second score component “score component 2” is assigned to the initiative, and if the selected value is “value 3,” the scoring engine 221 assigns a third score component “score component 3” to the initiative. The data structure 400 can include this type of information for each evaluation parameter in the set of evaluation parameters that are used to evaluate the technology development initiatives.

As shown in FIG. 5, a data structure 500 includes information regarding evaluation parameter groups. For example, a first group “group A” includes information that indicates that the first group includes “evaluation parameter 001,” “evaluation parameter 006,” “evaluation parameter 010,” and “evaluation parameter 011.” Additionally, the data structure 500 can include descriptive information about the first group, such as that the first group contains evaluation parameters that are related to expected or potential costs of the initiative, or to other resources required by the technology development initiative. Other groups may include evaluation parameters that are related to other types of features of the technology development initiative, such as duration, potential value, or area of impact, among others.

In addition to the list of the evaluation parameters that are included in the groups, the data structure 500 includes an evaluation parameter group scoring rule for each evaluation parameter group. A first evaluation parameter group scoring rule “rule A” can be used by the scoring engine 221 to modify score components generated for the evaluation parameters included in the evaluation parameter group “group A.” For example, the scoring engine 221 generates a final score component for the evaluation parameter 001 that is a product of the score component (i.e., score component 1, score component 2, or score component 3) generated by application of the evaluation parameter scoring rule and a constant value of 4/5. Thus, if an evaluation parameter scoring rule generates a score component of “X,” the final score component is 4X/5. The data structure 500 includes this information for each evaluation parameter group.

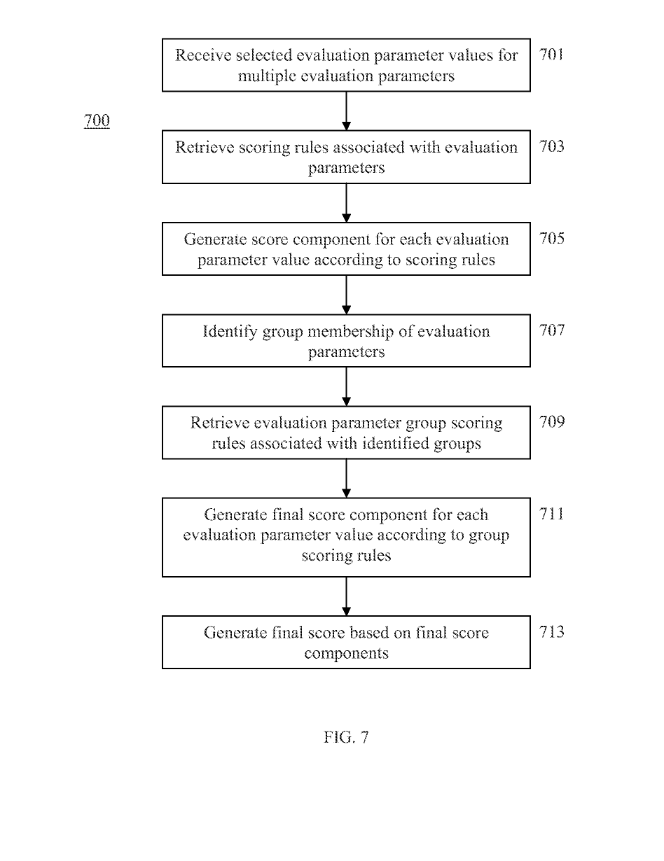

In some implementations, a technology development initiative can be evaluated according to a process 600, illustrated in FIG. 6. Specifically, the representative 110, or another user, can use the user interface 211 to select an evaluation parameter value that corresponds to an attribute or feature of the initiative for each evaluation parameter included in the evaluation parameter set (e.g., each evaluation parameter for which information is stored in the data structure 400) (601). The user interface then stores the selected evaluation parameter values (603). The selected evaluation parameter values can be stored in a data repository. The selected evaluation parameter values are then transmitted to the scoring engine 221, or another processor (605). When the scoring engine 221 receives the selected evaluation parameter values for the initiative (607), the scoring engine 221 generates a score component for each of the selected values (609). When all of the selected values have been used to generate score components, the scoring engine 221 generates final score components (611). The final score components can be generated by adjusting the score component for each evaluation parameter according to a group scoring rule for an evaluation parameter group to which the evaluation parameter belongs. For example, the final score components can be generated as discussed above with respect to FIG. 5. The scoring engine 221 then generates a final score (613), such as by summing all of the final score components, and stores the final score in the initiative score repository 229 (615).

As discussed above, the stored final score for the initiative can be used by comparison with initiative scores for other technology development initiatives, or by comparison with threshold score values. For example, members of the review panel 120 can generate and transmit a query to the score engine 221 or to another system, such as a score reporting system, to access one or more final scores associated with initiatives (617). The score engine 221 then accesses the stored final initiative score for one or more initiative (619), compiles a final score report (621), and transmits the final score report to the members of the review panel 120 (623). For example, the scoring engine 221 can access the stored final score for all initiatives currently under review, or all initiatives analyzed during a selected time period, such as the preceding month. The scoring engine can compile the final score report by listing all of the initiatives and their associated final scores. The list can be ranked, such as in descending order of score, and can be categorized. For example, the list can include groups arranged by categories of attributes. In one example, the final score report could have three tiers, associated with a high budget, a medium budget, and a low budget. Within each tier, the initiatives that meet the respective budget requirements for the tier can be ordered in descending order of final score value. In another example, the final score report can organized such that the initiative that has the greatest expected return on investment is listed first. The final score report can also be organized taking into account time concerns, such as an expected time of development, or an expected remaining time of development. The initiatives can be arranged into the groups based on the evaluation parameter values selected for one or more evaluation parameters, such as an evaluation parameter associated with expected budget. For example, for a relevant evaluation parameter, such as one that indicates a needed budget, initiatives that have the same selected evaluation parameter value are grouped together and can be arranged in descending order of score within the group.

Regardless of organization, the final score for each of the initiatives in the final score report can be generated using the same set of evaluation parameters and the same set of possible values for the evaluation parameters. Thus, the final scores provide a consistent and objective measure of value, as defined by the scoring rules for the evaluation parameters and by the scoring rules for the groups of evaluation parameters. The scoring rules may also reflect a general judgment of value as perceived by the organization using the framework 100 and/or the system 200 to analyze initiatives. As the value judgments of the organization change, the rules can be changed. In particular, the evaluation parameter group scoring rules can be adjusted to emphasize or de-emphasize the importance of a group of evaluation criteria, such as where a particular market or market segment increases or decreases in importance to the organization, or where a particular product or service (or product or service class) increases or decreases in importance to the organization.

In some implementations, a process 700, illustrated in FIG. 7, can be used to generate the final score for an initiative. In the process 700, the scoring engine 221 receives a set of selected evaluation parameter values that includes one selected evaluation parameter value for each evaluation parameter in the set (701). The selected evaluation parameter values can be received from the user interface 211. The scoring engine 221 also retrieves, for each of the parameter values, a scoring rule that applies to the selected evaluation parameter value (703). The scoring rules can be retrieved from the evaluation parameter scoring rule repository 223, from a storage device that includes the data structure 400, or from another source, depending on the implementation. Each selected evaluation parameter value is then converted to an associated score component based on the scoring rule that applies to the evaluation parameter (705).

The scoring engine 221 then identifies the evaluation parameter groups to which the evaluation parameters belong (707). For example, the scoring engine may identify the groups by referring to the data structure 500 that includes information regarding which evaluation parameter identifiers are associated with each group. The scoring engine 221 then retrieves the scoring rule for each of the identified evaluation parameter groups (709). The scoring rules may also be retrieved from the data structure 500. The scoring engine 221 then converts the generated score components using the evaluation parameter group scoring rules to generate a final score component for each evaluation parameter (711). For example, the scoring engine 221 may multiply the score components for evaluation parameters in a first group by a first constant value, or the scoring engine 221 subtract a predetermined amount from each of the score components associated with the evaluation parameters in the first group. Finally, the scoring engine 221 generates a final score for the initiative using the generated final score, components (713). In a simple example, the final score components can be summed. However in other examples, the final score can be generated from the final score components in other ways, such as by averaging the score components, or by adding the ten greatest final score component amounts.

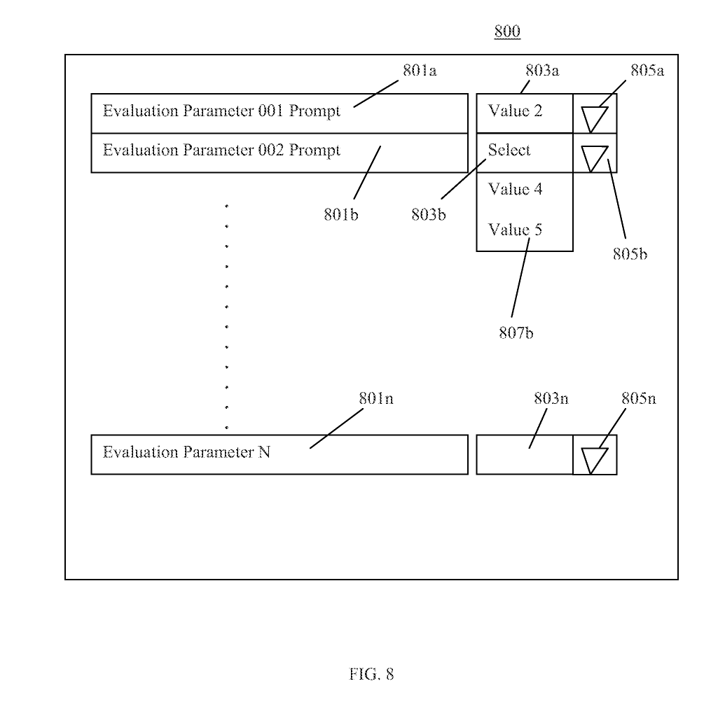

Now referring to FIG. 8, a user interface 800 can be used to allow an individual to select and transmit evaluation parameter values for use in evaluating an initiative. As illustrated, the user interface 800 includes evaluation parameter prompts 801a-801n that prompt the individual to select an evaluation parameter value. The user interface 800 also includes evaluation parameter value selection elements 803a-803n. The evaluation parameter prompts 801a-801n can include questions and/or instructions that guide the individual in selecting a proper value using the corresponding evaluation parameter selection elements 803a-n. For example, the evaluation parameter prompt 801b can include the question, “how many months will be necessary to complete the initiative?” Alternatively, the same information could be solicited with an instruction that reads, “select the choice that reflects the number of months necessary to complete the initiative.” In either case, the evaluation parameter selection element 803b can include two choices, value 4 and value 5. Value 4 can be “12 months or less,” and value 5 can be “greater than 12 months.” Thus, evaluation parameter 002 relates to an amount of time necessary to complete the initiative. The appropriate value can be selected by the individual by activating a drop-down menu button 805b to display a choice field 807b. The appropriate evaluation parameter value can be selected from the choice field 807b by the individual and entered using the evaluation parameter selection element 805b by the user interface in response to the individual's selection. For example, value 2 was previously selected by the individual in response to the prompt for evaluation parameter 001 in prompt 801a.

In some implementations, the final score can be displayed to the individual during or after completion of the selections using the user interface 800. As illustrated, the final score is not shown. This may prevent unwanted manipulation of the final score by the individual's selection of values that increase the final score rather than accurately reflect the corresponding attribute of the initiative. For the same reason, the scoring rules may also not be displayed in the user interface 800.

While some implementations are described above, these should not be viewed as exhaustive or limiting, but rather should be viewed as exemplary, and included to provide descriptions of various features. It will be understood that various modifications may be made. For example, the steps of the described exemplary processes can be performed by one or more different entities, systems, and or system components. For example, while a technology development initiative is used in some implementations described above, other investments relating to initiatives or proposals can be evaluated and/or reviewed as described in this disclosure. Based on the review, decisions can be made regarding allocation of funds from a budget and/or time of employees for use in implementing one or more initiatives or proposals. In some implementations, proposed monetary investments in facilities, equipment, and/or personnel can be evaluated. Additionally, while the evaluation parameter value set repository and the evaluation parameter scoring rule repository are illustrated as separate, they can be combined in a single storage device or group of storage devices, such as where the data structure 400 is used that includes information from both repositories. Similarly, other components that are described as separate can be combined, and components can include multiple separate sub-components. With regard to the processes described above, the steps of the described processes can be performed in any order that achieves the described results.

Accordingly, other implementations are within the scope of the following claims.

1. A method, comprising:
receiving, for an associated investment proposal for an organization, a selected value for each evaluation parameter of a predetermined set of evaluation parameters, the evaluation parameters being selected for evaluating one or more characteristics of investment proposals;
generating, by at least one computer processor, a score for the associated investment proposal based on the received values and a rule set, the rule set providing instructions for generating a score for an investment proposal using selected values for each evaluation parameter; and
outputting the score for the associated investment proposal for use in evaluating the associated investment proposal,
wherein generating a score for the associated investment proposal includes processing each selected value according to a scoring rule associated with the corresponding evaluation parameter to generate score components,
wherein the evaluation parameters are associated with parameter categories, and
wherein generating the score for the associated investment proposal includes processing the score components for each evaluation parameter in a category according to a scoring rule associated with the category.

2. The method of claim 1, wherein the selected values are selected from a predetermined set of parameter values.

3. The method of claim 1, further comprising receiving updated selections, generating an updated score for an initiative associated with the investment proposal, and outputting the updated score for the associated initiative for use in evaluating a progress of the initiative.

4. The method of claim 1, wherein the score for the associated investment proposal is output in a display that includes a score for at least one additional investment proposal.

5. A system comprising:
one or more receivers that receive, for an associated investment proposal for a service delivery organization, a selected value for each evaluation parameter of a predetermined set of evaluation parameters, the evaluation parameters being selected for evaluating one or more characteristics of investment proposals;
one or more computer processors that generate a score for the associated investment proposal based on the received values and a set of scoring rules, the set of scoring rules including instructions for generating a score for an investment proposal using selected values for each evaluation parameter; and
one or more storage devices that store the scoring rules and that store the generated score.

6. The system of claim 5, wherein the one or more storage devices store predetermined sets of parameter values, and wherein the selected values are selected from the predetermined sets of parameter values.

7. The system of claim 5, wherein:
the one or more receivers receive, for an implementation associated with the investment proposal, updated selections;
the one or more computer processors generate an updated score for the initiative associated with the updated selections; and
the one or more storage devices store the updated score for the associated initiative for use in evaluating a progress of the initiative.

8. The system of claim 5, further comprising a display device that displays the score for the associated investment proposal with a score for at least one additional investment proposal.

9. The system of claim 5, wherein the one or more computer processors generate the score for the associated investment proposal by processing each selected value according to a scoring rule associated with the corresponding evaluation parameter to generate score components.

10. The system of claim 9, wherein the evaluation parameters are associated with parameter categories, and wherein the one or more computer processors generate the score for the associated investment proposal by processing the score components for each evaluation parameter in a category according to a scoring rule associated with the category.

11. A tangible computer-readable storage medium having a computer program product stored thereon, the computer program product including instructions that, when executed by one or more computer processors, enable:
receiving, for an associated investment proposal for a service delivery organization, a selected value for each evaluation parameter of a predetermined set of evaluation parameters, the evaluation parameters being selected for evaluating one or more characteristics of investment proposals;
generating a score for the associated investment proposal based on the received values and a rule set, the rule set providing instructions for generating a score for an investment proposal using selected values for each evaluation parameter; and
outputting the score for the associated investment proposal for use in evaluating the associated investment proposal.

12. The computer-readable medium of claim 11, wherein the selected values are selected from a predetermined set of parameter values.

13. The computer-readable medium of claim 11, wherein the instructions further enable receiving updated selections, generating an updated score for an initiative associated with the investment proposal, and outputting the updated score for the associated initiative for use in evaluating a progress of the initiative.

14. The computer-readable medium of claim 11, wherein the score for the associated investment proposal is output in a display that includes a score for at least one additional investment proposal.

15. The computer-readable medium of claim 11, wherein generating the score for the associated investment proposal includes processing each selected value according to a scoring rule associated with the corresponding evaluation parameter to generate score components.

16. The computer-readable medium of claim 15, wherein the evaluation parameters are associated with parameter categories, and wherein generating the score for the associated investment proposal includes processing the score components for each evaluation parameter in a category according to a scoring rule associated with the category.
